(19) United States
(12) Patent Application Publication
(10) Pub. No.: US 2011/0089097 A1
(43) Pub. Date: Apr. 21, 2011

(54) Attachment and system for dewatering material

(76) Inventor: Dominick O'Reilly, Carton North Tooreen Ballyhaunis (IE)

(21) Appl. No.: 12/589,110

(22) Filed: Oct. 19, 2009

(51) Int. Cl. B01D 25/21; B01D 25/32

(52) U.S. Cl. 210/225; 210/226

(57) ABSTRACT

A system (300) and attachment (200) for removing water from a material is disclosed. The system (30) can include: transporting (310) a material to be dewatered on a porous conveyor belt; conveying (320) the material to be dewatered between a top press attachment and bottom press attachment to release moisture; expelling (330) moisture to a porous buffer structure above the material in the top press attachment and below the material in the bottom press attachment; directing (340) the expelled moisture to a top and bottom tray of the top and the bottom press attachments; and draining (350) the top and bottom trays. Advantageously, the system (300) and attachment (200) provide two major escape routes for dewatering and provides a reliable, high volume assembly line batch process for efficient and robust operations.

### FIELD OF THE INVENTION

The present invention relates to an improved system for treating waste, and in particular an improved attachment and system for dewatering material, such as peat, sludge or a bio-solid material.

### BACKGROUND OF THE INVENTION

Throughout the world every year millions of tons of peat are harvested. Peat is mainly used in horticulture and as a fuel. There are various types of peat, ranging from dark heavy material to a lighter brown material. Peat was formed over millions of years from many types of vegetation. The areas where peat is found are commonly referred to as boglands, marshlands or peatlands. In order to harvest peat, it is necessary to dry it as much as possible. The primary methods of drying are wind, sunshine and warm and dry weather and also thermal drying by means of heat generated by electricity, coal, wood, oil or indeed peat itself.

Peat taken directly from the ground is generally comprised of 70-95% moisture. The material is generally very fibrous and difficult to dewater. Many people have tried various means of dewatering this material, but they have been unsuccessful. Many have tried and been successful to an extent, but in doing so have created greater problems than they set out to solve in that the amount and nature of the chemicals they added to the peat were either financially not viable or created a liquor, concentrate or wastewater that was difficult to treat and dispose of.

In order to use peat as a fuel in peat powered power plants, the peat should be no greater than 45-48% moisture. In order to manufacture briquettes the moisture needs to be approximately 10%. In order to achieve these levels of moisture one needs to have a consistently good drying climate or use vast amounts of energy to dry the peat. Also in the manufacture of peat moss, the material has to conform to standards that state that the moisture content is at acceptably low levels.

Accordingly, it would be considered an improvement in the art, to be able to remove the moisture from peat and other materials, such as waste, as simply, cleanly and economically as possible.

Similarly, in practically all municipal wastewater treatment plants, waste water is separated into treated water and waste material. The waste material is in the form of a sludge comprising both solid and liquid material, the majority of the material being liquid. Before transporting the waste material from one location to another for further processing, it is advantageous to remove as much moisture or liquid from the sludge as possible, as this reduces the weight of the sludge. Also, the lower the percentage of moisture or liquid in the sludge, the lesser the chance of groundwater contamination due to seepage from the sludge.

It is known to initially de-water the sludge into a semi-solid sludge cake through drying and/or settling techniques. However, this sludge cake retains a substantial portion of moisture, requiring further treatment.

It is also known to employ compression apparatus, for example belt presses, filter presses, screw presses, centrifuges, in an effort to squeeze moisture out of the sludge cake. However, because of the consistency of the sludge cake, or due to the presence of certain polymers or flocculants within the sludge itself, it can be quite difficult to effectively eliminate moisture content beyond a certain level from the sludge. In general, conventional techniques are only capable of eliminating that level of moisture to achieve a moisture content of 75-80% in such waste material. Under further compression, the sludge tends to bind and ooze in any direction possible, effectively behaving like a hydraulic fluid.

A system for solving these problems would be considered an improvement in the art.

### BRIEF DESCRIPTION OF THE DRAWINGS

An embodiment of the invention will now be described, by way of example, with reference to the following drawings, in which:

FIG. 1 is a schematic drawing of a waste treatment system, in accordance with the instant invention.

FIG. 2 is a cross-sectional view of a sample compression apparatus of FIG. 1.

FIG. 3 is a flow diagram of an embodiment of the system, in accordance with the invention.

FIG. 4 is a simplified cut-away view of a press attachment, in accordance with the invention.

FIG. 5 is a simplified perspective view of the press attachment, in accordance with the invention.

FIG. 6 is a block diagram of a system for dewatering a material, in accordance with the invention.

FIG. 7 is a simplified side view of the system for dewatering a material during a press cycle, showing the moisture in a lower portion of the material being expelled downwardly and the moisture in an upper portion of the material being expelled upwardly, in accordance with the invention.

FIG. 8 is a simplified side view of the system for dewatering a material during a press cycle, showing the moisture in the material being: (i) expelled to a first stage; (ii) conveyed to a second stage; and (iii) then drained, in accordance with the invention.

### DESCRIPTION OF A PREFERRED EMBODIMENT

According to an embodiment of the present invention there is provided a method of removing water from sludge. The method comprises adding to the sludge a blending material having a porous structure in a weight ratio of relatively wet sludge to relatively dry blending material of about from 2:1 to about 10:1.

As used herein, the term “sludge” has its common ordinary meaning, and is intended to mean the solid, semi-solid, or liquid waste or precipitate generated in the treatment of wastewater (e.g. sewage or slurry).

In a preferred embodiment, the blending material is a compressible material.

Advantageously, the introduction of a suitable blending material into the sludge prior to compression can result in a greater portion of moisture being removed from the sludge, in some cases approaching or in excess of about 60-70% moisture removal, which is considered a substantial improvement in the field.

Suitable blending materials can vary and in one embodiment can include cellulose-based materials, for example wood shavings, newsprint and milled peat. In addition, trommel fines, for example, the particles collected via trommel screens during the recycling of household waste, can also be employed as a blending material. Open-cell sponges can also be used.

In one embodiment, the blending material comprises fine wood dust, and in a preferred embodiment, it is treated with a urea formaldehyde resin.

It has been found that dust collected during the machining of Medium Density Fibreboard (MDF) is also effective as a blending material, for example, what is referred to as sander dust.

In one embodiment, the ratio of sludge to blending material is from about 2:1 to about 10:1, and preferably from about 8:1 to about 10:1, dependent on such factors, as the type of waste and the moisture content of the waste, for example.

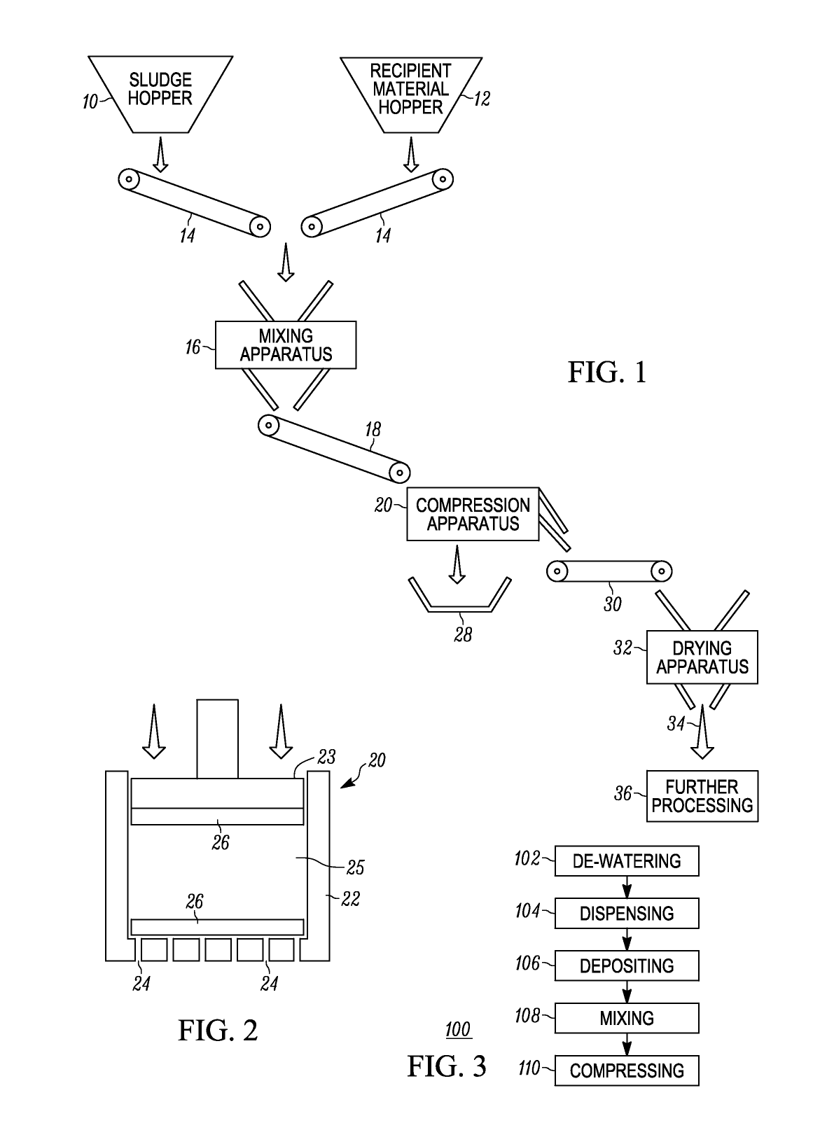

Referring to FIG. 1, a waste treatment system according to a preferred embodiment is shown. Sludge, as output from a wastewater treatment plant or other suitable producer of wastewater material, is initially de-watered into a semi-solid sludge cake. The sludge cake is collected in a sludge hopper 10. A suitable blending material to be mixed with the sludge cake is collected in a hopper 12.

Preferably, the blending material is a compressible material. Suitable blending materials include cellulose-based materials, for example wood shavings, newsprint and milled peat. Dust collected during the machining of Medium Density Fibreboard (MDF) is also effective as a blending material, also referred to as sander dust. In addition, trommel fines or particles collected via trommel screens during the recycling of household waste, can also be employed as blending material. Open-cell sponges may also be used.

In a preferred embodiment, fine wood dust treated with a urea formaldehyde resin can provide good results when used as a blending material. A urea formaldehyde resin is found in MDF wood dust, and it is believed that the presence of this resin contributes to the effectiveness of the compression.

In more detail, tests performed by the applicant suggest that the presence of the resin solidifies the MDF dust particles, substantially minimizes the possibility of and/or substantially prevents the particles from collapsing under the pressure exerted during compression. The applicant believes that the rigidity of the resin solidifies the MDF dust particles, to effectively provide an escape route for the water or moisture, out of the material, while minimizing the composite material from acting like a consistent hydraulic fluid.

As shown in FIG. 1, the sludge cake and the blending material are dispensed from their respective hoppers 10,12 to separate conveyors 14. The sludge cake and the blending material are deposited into a suitable mixing apparatus 16. It will be understood by those skilled in the art, that the mixing apparatus 16 may be chosen from at least one of a paddle mixer, screw mixer, agri feed mixer and any mixing or blending device, as known in the art.

The mixing apparatus 16 blends the sludge cake and the blending material together to create a composite mixture. The mixing apparatus is operable to mix the sludge cake and the blending material together, preferably at a slow rate, such that the mixture is folded together rather than beaten, for improved mixing for example.

In a preferred embodiment, the mixing process is performed by folding successive layers of sludge cake into contact with layers of the blending material. Further mixing is accomplished through the continued folding together of layers of the composite mixture, until the concentration of the composite mixture is substantially evenly spread.

The ratio of blending material to sludge cake in the composite mixture may be adjusted depending on the type of blending material used. For example, when using wood shavings, a sludge cake to blending material weight ratio of about 10:1 has been found to be most effective, while in the case of milled peat the preferred ratio is about 2.5:1.

In the case of MDF dust material, a preferred ratio of sludge cake to dust ranges from about 5:1 to about 2.5:1, depending on the dry matter content of the sludge cake.

As shown in FIG. 1, the composite mixture exits the mixing apparatus 16 onto a conveyor 18. The composite mixture is then delivered to a compression apparatus 20. The compression apparatus 20 may be chosen from any one of a belt press, a screw press, a plate press, a batch press, a filter press, a hydraulic press, or any compression device as known in the art. The compression apparatus 20 is configured to allow the release of moisture from the contained mixture during compression.

For example, the compression apparatus 20 may comprise a plate press having a conveyor located within the compression apparatus to firstly convey the composite mixture into the compression apparatus, and to secondly convey the composite mixture after compression out of the compression apparatus for further processing. The conveyor can be configured to allow the release of moisture from the contained mixture during compression. For example, in the case of a standard belt conveyor, the belt can be perforated to allow the moisture to drain through the conveyor belt. One or more of the plates used in the plate press can also be perforated, to allow the escape of moisture during compression.

As shown in FIG. 2, a cross-section of a sample compression apparatus 20 is depicted. In this case, an enclosed plate press 22 comprising a compression ram 23 and an interior chamber 25, is shown. The compression apparatus 20 is provided with a series of apertures 24 to allow the drainage of moisture from the device 20. In FIG. 2 of the plate press 22, the apertures 24 are provided in the surface of the plate press 22 that the compression ram 23 acts against.

Initially, the ram 23 is maintained in an ‘at rest’ position at that side of the plate press 22 opposite to the apertures 24, for example, the top of the plate press 22. In order to prevent the composite mixture itself from being squeezed through the apertures during compression, a filter material 26 is provided over the apertures 24 and over the surface of the ram 23 acting on the composite mixture. The filter material 26 can be made from any porous material that allows through passage of liquids and minimizes the flow of solids, for example, such as cotton.

In operation, the composite mixture is supplied to the interior chamber 25 of the plate press 22. During compression, the ram 23 is driven in a downwards direction, towards the apertures 24. As the composite material is compressed, moisture is forced from the mixture, in the form of wastewater. The expelled wastewater then passes through the filter material 26, and exits the plate press 22 through the apertures 24. Referring back to FIG. 1, the wastewater is then collected in a suitable drain 28.

It will be understood that the above configuration for the plate press may be adapted as required for the other types of compression apparatus as mentioned, i.e. that the compression apparatus are configured to allow the escape of wastewater during compression, while retaining the solid material.

Preferably, the compression generally occurs at pressures between 1379 kPa (200 psi) and 13789 kPa (2000 psi). A large amount of wastewater is expelled from the mixture at lower pressures, but if compression is maintained at these levels, the majority of wastewater is substantially eliminated from the mixture. In a preferred embodiment, the pressure is applied gradually, and is maintained for a period of time to ensure maximum de-watering of the composite mixture. For example, for a portion of composite mixture having a width of approximately 101.6 cm (40 inches) and a depth of approximately 101.6 cm (40 inches), the period of time for compression to substantially ensure maximum dewatering should be at least 30 seconds.

The wastewater expelled from the composite mixture can then be returned to the wastewater treatment plant for further processing and refinement.

The presence of the blending material in the composite mixture allows for a greater proportion of moisture to be squeezed from the sludge cake. Expelling the moisture from the composite mixture produces a substantially de-watered resultant material, with a dry solids content of upwards of 35%.

The resultant material is removed from the compression device 20 and brought by conveyor 30 to drying apparatus 32. The substantially de-watered resultant material is more easily dried due to the reduced levels of moisture present. The drying apparatus 32 can be one of a cyclonic dryer, a thermal dryer, an air dryer, a drum dryer, or any drying device as known in the art, for example the Tempest Drying System manufactured by GRRO Incorporated is one such device.

After drying, the resultant material is substantially solid. The solid material exits the drying apparatus at 34 and can then be further processed (system or apparatus) 36, depending on the application. For example, the further processing 36 can be a pelletiser, to convert the solid material into pellets for burning as fuel.

It will be understood that the resultant material can also be utilised as a substitute for the blending material to be mixed with the sludge cake. It has been found that the resultant material produced by the process may be re-used as blending material for approximately three iterations, before the de-watering effects start to decline.

In an alternate embodiment, the mixing and compression steps can be performed on location at a waste treatment plant, with the drying (and possibly palletising) steps performed at a remote location. In this case, the drying apparatus 32 in FIG. 1 may be replaced by a truck or suitable transport device that transfers the resultant material output from the compression apparatus 20 to a centralised location where the drying and palletising stages are carried out.

Alternatively, the waste treatment apparatus itself may be provided as part of a mobile waste collection system. In this case, the hoppers 10,12, mixing apparatus 16, and compression apparatus 20 are provided as part of a vehicle, for example on the rear of a truck, or on a truck trailer. The drying apparatus 32 may optionally be provided as part of the vehicle or, as above, the drying and further processing stages of the method may be performed at a remote location. An advantage of this mobile system is that businesses, for example farmers, that may not be able to afford construction of the system or would not be in a position to continually utilise the system, could be visited by the mobile apparatus, such as by a waste service provider, for the treatment of their waste.

Use of this process or system, can result in a reduced moisture-level end product, with more manageable properties and a dry solids content approaching upwards of 50-70%. The end material is substantially reduced in weight as opposed to conventional moisture extraction techniques, and is more easily transportable.

As shown in FIG. 3, a system for removing water from sludge 100, is shown. In one form, the system 100 includes: de-watering 102 sludge comprising an output from a wastewater treatment system to form a semi-solid sludge cake; dispensing 104 the sludge in a sludge hopper and dispensing a blending material in a recipient blending material hopper; depositing 106 the sludge and the blending material in a mixing device; mixing 108 the sludge and the blending material having a porous structure in a weight ratio of the sludge to the blending material of about from 2:1 to about 10:1; and compressing 110 the sludge and the blending material to release moisture.

Advantageously, the system 100 provides an improved method of de-watering sludge, for more efficient processing, transporting and recycling, depending on the application. Advantageously, the system 100 can dewater sludgecake from a wastewater stream, for example, and further dewater the sludgecake, which can then be recycled, reused or disposed of. This system can be environmentally friendly, by providing recycling and/or producing less material needing disposal, for example.

In one embodiment, the system 100 can improve dewatering of sewage sludge, both in undigested or undigested applications, and in a preferred embodiment, in a digested application, for example, the sludge is pre-processed in a container where anaerobic digestion and processing occurs.

The system 100 has a wide variety of potential applications. For example, the system can be used in sludges in connection with the processing of: human, animal and the like waste; aluminium, ferrics and the like; pharmaceutical products; chemical products; semiconductor products; drugs and foods, such as in meat and milk processing, and the like.

As detailed herein, in a preferred embodiment the blending material comprises a cellulose-based material treated with a urea formaldehyde resin, such as dust collected from machining of Medium Density Fibreboard (MDF).

The blending material can vary widely. For example, in a preferred embodiment, it can include any processed wood board in the form of a substantially fine dust from an MDF wood board, chipboard or particle board, oriented strand board and the like, provided it comprises a compressible material, such as a resilient binding material, such as glue, resin such as urea formaldehyde, and the like. The compressible material includes a crystalline spacer-like structure adapted to substantially maintain at least some or most of its structure during compression, to allow the water to be escape. Other dry wood dust can be used as well.

In one embodiment, the blending material comprises a compressible material of about 25% or less by weight of the blending material for improved dewatering during compression, and preferably about 10% to about 20% by weight of the blending material, for improved dewatering during compression.

As previously stated, the compressible material provides a crystalline spacer-like structure adapted to substantially maintain its structure during compression, to allow the water to be escape. It is believed that, during initial compression the spacer-like structure allows an escape path, defining a first stage, and after the first stage, the spacer-like structure can slightly deform to allow additional water to escape, defining a second stage. In more detail, the crystalline spacer-like structure in the first stage has a first diameter that allows water to escape. In the second stage, the crystalline spacer-like structure has a second diameter, which is less than the first diameter, to allow further water to escape.

In a preferred embodiment, the compressible material comprises a urea formaldehyde resin, which can be obtained from a binder supplier. This material is commonly used to bind the MDF, OSB or particleboard together and is added in the manufacturing process.

Additional blending materials can be used, such as wheat, barley, oats, rice and straw. By pulverizing and impregnating or treating these blending materials, good dewatering results can occur. In a preferred embodiment, these additional blending materials can be used if first processed by a Hammermill or similar device, in order to produce a powder or coarse material, adapted for mixing with a sludgecake, for improved dewatering.

In the event the feed stock blending material does not include a compressible material, a compressible material can be added to and mixed in the blending material. For example, in FIG. 1, a sludge hopper 10, material hopper 12 and an additional hopper for the compressible material (not shown in FIG. 1), can be fed via lines 14 and mixed in mixing apparatus 16. This can substantially improve dewatering during compression, as compared to the absence of the compressible material. As should be understood by those skilled in the art, other ways can be implemented, for mixing these three constituents.

In a preferred embodiment, the mixing step 108 includes folding successive layers of sludge cake with the blending material and forming a composite mixture, such that the sludge and blending material are substantially evenly spread, for improved de-moisturization.

In a preferred embodiment, the mixing step 108 can include substantially homogenous mixing, to provide improved dewatering, provided the correct ratios are maintained. Rapid or slow mixing can be used. In a preferred embodiment, the mix should be of a texture being substantially evenly mixed throughout. Over mixing can disadvantageously result in a pasty-like material that is not adapted for dewatering in this process. Depending on the moisture content of the sludgecake, the amount of blending material for use in connection with this system can vary. For example, in one embodiment, the amount of blending material can be about 5% by weight to about 60% by weight, for providing the desired consistency of the mix.

Also in a preferred embodiment, relative to the mixing step 108, the weight ratio of the sludge cake to blending material is about 10:1 when the blending material comprises wood shavings, the weight ratio of the sludge cake to blending material is about 2.5:1 when the blending material comprises milled peat, and the weight ratio of the sludge cake to blending material is about 5:1 to about 2.5:1 when the blending material comprises a cellulose-based material treated with a urea formaldehyde resin, for improved de-watering of sludge.

The compressing step can vary. In a preferred embodiment, mix is placed or poured in a compressive device and subjected to a certain pressure for desired dewatering. The mixed can be placed on a porous belt, such as a polyester, polyamide or cloth belt, with an air permeability of about 360 cubic feet/minute (CFM) at a pressure of 125 PA. In more detail, the belt can be placed or positioned on a porous rigid plate that is raised. The plate can have 5 mm holes at 15 mm centers, spaced throughout. The mixed can be subjected to pressure by means of a push plate. The mixed can be compressed or squeezed, and the moisture and water is expelled through the porous belt and holes. The amount of pressure required to expel the water varies, and is discussed in more detail in Example 2.

The system 100 can further include at least one of drying the compressed mix in the compressing step 110, and converting it to form a solid material adapted for use as fuel, re-use as a blending material and the like.

In one embodiment, the system 100 can include further processing, such as: (i) macerating and/or pulverizing the dewatered sludgecake in order to break up and separate the blending material or dust particles comprising smaller particles, from the larger dewatered sludgecake particles. This can be done with various machines, such as a hammer mill, high speed mixer and the like; And, (ii) separating the blending material and dewatered sludgecake. Since the particles of the dewatered sludgecake and blending material, such as wood dust are different sizes, separation can be done in a vibratory screen process. For example, the dewatered sludgecake with blending material is fed into a vibratory screen sizer, whereby the blending material or dust can fall through the screen and be separated from the dewatered sludgecake. The blending material can be reclaimed for reuse a few more times and the dewatered sludgecake can be disposed, recycled, etc.

In yet more detail, over years of research and development and extensive trial and error, Applicant has discovered that certain materials when mixed correctly and substantially thoroughly incorporated into a wet material, such as sludge cake, sewage, pharmaceutical sludge, dairy sludge, food processing sludge, oil sludge, water purification sludge, animal slurry, fruit waste, fresh peat, milled peat, paper sludge, de-inking sludge, paper fibers, recycled diaper waste at varying concentrations and the like, allows the resulting or treated material to be compressed at high pressure, thereby allowing large amounts of water to be expelled from the treated material.

In a preferred embodiment, these materials are conditioned or pre-conditioned in a certain manner to allow the water to be expelled. In a preferred embodiment, the dewatering agents are milled to a very fine consistency, such as at a size of about 500μ or less. Thus, the pre-conditioned dewatering agents will have a consistency akin to sander dust or flour. With a fine consistency, the pre-conditioned dewatering agent presents a large surface area and during a predetermined short vigorous mixing, will substantially evenly disperse throughout the wet material. In one embodiment, the dewatering agents that provide good results are finely milled rice husks, finely milled nut shell, finely milled corn cob, finely milled palm frans, finely milled bamboo, finely milled strand board, finely milled wood, and finely milled polyethylene powder. In a preferred embodiment, the polyethylene powder comprises Borealis rm8343, obtainable from Borealis.

Various conditioned or pre-conditioned materials, also referred to herein as “blending materials and/or dewatering agents,” require different ratios to obtain the desired dewatering effect. For example, in a preferred embodiment, when using milled strand board, a sludge cake to dewatering agent weight ratio of about 10:1 has been found to be most effective, depending on the moisture levels of the material to be dewatered. This holds true for many of the dewatering agents. In a preferred embodiment, when a polyethylene powder is utilized as a dewatering agent, a sludge cake to dewatering agent weight ratio of about 1:1 has been found to be most effective. Generally, about 50 to 80 percent of the moisture in these materials to be dewatered, can be removed in this process. After the material has been compressed, it is removed from a compression chamber and can be macerated vigorously for approximately 60 seconds. This can be done in a fast rotating mixer with chopping knives or similar device to substantially pulverize the material into a powder consistency. The pulverized material can then be fed over a vibrating screen, through an air separator or through a sieving device in order to separate the majority of the finely milled powder (dewatering agent) from the wet material that has been dewatered. This finely milled powder when recovered can be reused several times. In the case of the polyethylene powder, it can be separated from the dewatered material by sieving as described earlier or by using an electrostatic charge on the polyethylene, that allows it to be removed in a similar way as a magnet removes metal. The recovered polyethylene can be reused many times.

In one embodiment and in more detail, a system for removing water from sludge is shown and disclosed herein. It can include: depositing a semi-solid sludge cake and a dewatering agent in a mixing device; mixing the sludge and the dewatering agent having a porous structure in a weight ratio of the sludge to the dewatering agent of about from 1:1; and compressing the sludge and the dewatering agent to release moisture. Improved dewatering can be gained by following this system, as detailed herein.

The semi-solid sludge cake can comprise at least one of: sludge in connection with the processing of peat harvesting, human waste, animal waste, aluminium, ferrics, pharmaceutical products, chemical products, semiconductor products, drugs and foods, sewage sludge, oil sludge, water purification sludge, animal slurry sludge, fruit waste sludge, fresh peat sludge, milled peat sludge, paper sludge, de-inking sludge, paper fibers sludge and recycled diaper waste sludge. Thus, the system has a multiplicity of applications.

In a preferred embodiment, a conditioning or pre-conditioning of the dewatering agent to a fine consistency is utilized. The pre-conditioning step can include milling the dewatering agent to a size of about 500μ or less. Thus, the pre-conditioning of dewatering agents can provide a consistency akin to sander dust or flour. With a fine consistency, the conditioned or pre-conditioned dewatering agent presents a large surface area, and during a predetermined short vigorous mixing, will substantially evenly disperse throughout the wet material.

As an example, dewatering agents can comprise at least one of milled rice husks, milled nut shells, milled corn cob, milled palm frans, milled bamboo, milled strand board, milled wood, and milled polyethylene or polypropylene powder. A preferred dewatering agent comprises milled polyethylene powder, because it can be easily separated and reused a number of times.

In another embodiment, also as shown in FIG. 3, an improved waste treatment method for removing water from sludge is shown and disclosed. It includes the steps of: de-watering 102 the sludge comprising an output from a wastewater treatment system to form a semi-solid sludge cake; dispensing 104 the semi-solid sludge cake in a hopper and dispensing a dewatering agent in a recipient dewatering agent hopper; depositing 106 the semi-solid sludge cake and the dewatering agent in a mixing device; mixing 108 the semi-solid sludge cake and the dewatering agent having a porous structure in a weight ratio of the semi-solid sludge cake to the dewatering agent of about from 1:1; and compressing 110 the semi-solid sludge cake and the dewatering agent to release moisture.

Advantageously, the system 100 provides an improved method of de-watering sludge, for more efficient processing, transporting and recycling, depending on the application. Further, the system 100 can dewater sludgecake from a wastewater stream, for example, and further dewater the sludgecake, which can then be recycled, reused or disposed of. This system can be environmentally friendly, by providing recycling and/or producing less material needing disposal, for example.

In one arrangement, the dewatering agent is a compressible material, such as a crystalline spacer-like structure adapted to substantially maintain at least some or most of its structure during compression, to allow the water to be escape, as detailed previously.

As detailed previously, semi-solid sludge cake can comprise for example, at least one of sewage sludge, pharmaceutical sludge, dairy sludge, food processing sludge, oil sludge, water purification sludge, animal slurry sludge, fruit waste sludge, fresh peat sludge, milled peat sludge, paper sludge, de-inking sludge, paper fibers sludge and recycled diaper waste sludge. Advantageously, the method herein has a number of applications.

Examples of candidate dewatering agents include at least one of milled rice husks, milled nut shells, milled corn cob, milled palm frans, milled bamboo, milled strand board, milled wood, and milled polyethylene and milled polypropylene powder.

In a preferred embodiment, the mixing step 108 includes forming a composite mixture, such that the semi-solid sludge cake and the dewatering agent are substantially evenly dispersed, for improved de-moisturization during compression, as detailed earlier.

In yet another embodiment, the improved waste treatment method for removing water from sludge comprises the steps of: de-watering 102 the sludge comprising an output from a wastewater treatment system to form a semi-solid sludge cake; dispensing 104 the semi-solid sludge cake in a hopper and dispensing a dewatering agent in a recipient dewatering agent hopper; depositing 106 the semi-solid sludge cake and the dewatering agent in a mixing device; mixing 108 the semi-solid sludge cake and the dewatering agent having a porous structure in at least one of: a weight ratio of the semi-solid sludge cake to the dewatering agent of about from 1:1 when the dewatering agent comprises polyethylene powder; and a weight ratio of the semi-solid sludge cake to the dewatering agent of about from 10:1 when the dewatering agent comprises at least one of: milled rice husks, milled nut shell, milled corn cob, milled palm frans, milled bamboo, milled strand board, milled wood and a milled strand board; and compressing 110 the semi-solid sludge cake and the dewatering agent to release moisture forming a compressed material. Advantageously, the method provides for certain dewatering agents, for improved results.

In a preferred embodiment, the method includes conditioning the dewatering agent to form a fine consistency before the dispensing step; macerating the compressed material after the compressing step; and separating the semi-solid sludge cake and the dewatering agent making up the compressed material, for improved efficiencies and results. Advantageously, the separated semi-solid sludge cake is converted to form a solid material adapted for use as fuel and the dewatering agent is adapted for re-use as a dewatering agent, in one embodiment.

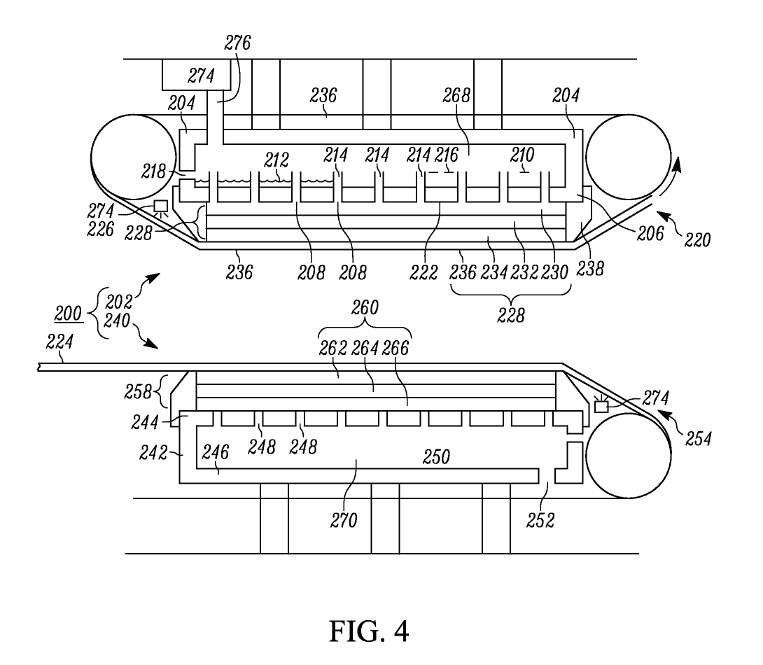

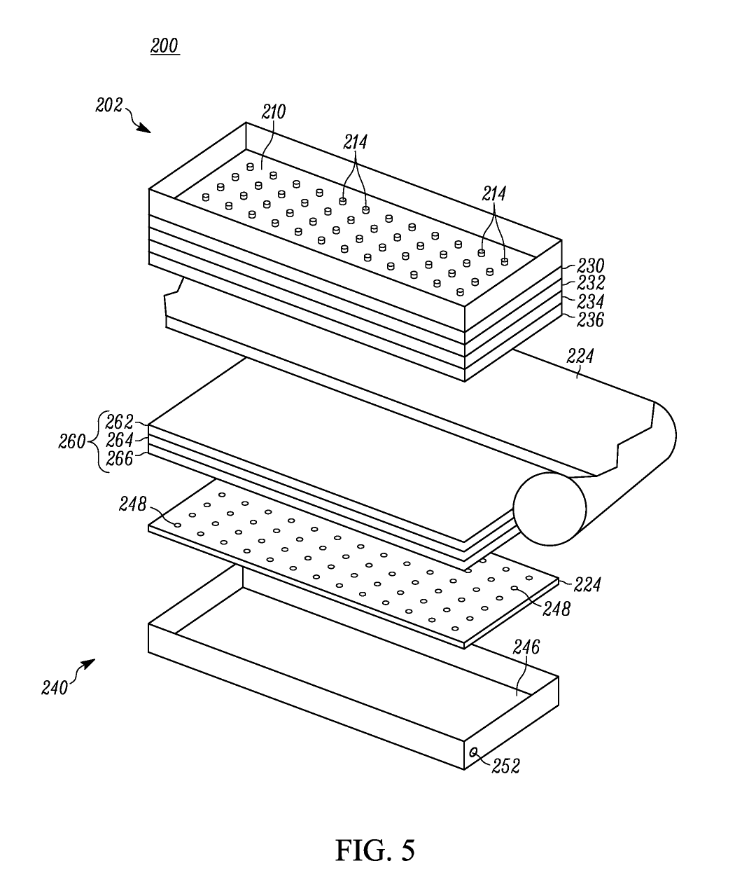

An improved press attachment 200 is shown in FIGS. 4 and 5. In its simplest form, it can include: a frame 202 including walls 204 and a floor 206 having a plurality of vias 208, the walls 204 and floor 206 defining a tray 210 adapted to hold a liquid; pipes 214 extending upwardly from the plurality of vias 208 a predetermined height 216 above the floor 206; the walls 204 having an drain opening 218; and a porous buffer structure 220 located below a bottom 222 of the floor 206 and connected to the frame 202. Advantageously, the press attachment 200 improves dewatering material to be dewatered. The attachment can provide a high volume assembly line batch process for efficient and robust operations.

The frame 202 can be generally rectangular, so when used with a conveyor 224, a lot of material can be dewatered in a single cycle or press. In one arrangement, the drain opening 218 is substantially positioned at least partially below the predetermined height 216 of the pipes 214 to allow the liquid to flow through the drain opening 218 due to gravity. This passive structure helps to minimize energy consumption. In one embodiment, a top 226 of the floor is inclined to provide a path to the drain opening 218.

In a preferred embodiment, the plurality of vias 202 have the same or different diameters and the pipes have the same or different diameters. This provides additional dewatering as needed, in varying areas needing it, such as where water tends to surge during the beginning of a press cycle.

The porous buffer structure 220 can be configured as a first stage queuing station 226 adapted to absorb liquid for a certain period of time. In a preferred embodiment, the queuing station 226 can include a plurality of porous layers 228 that absorb liquid during a press cycle.

In more detail, in a preferred embodiment, the porous layers 228 can include a first layer 230 being a fine mesh screen to minimize pot-mark like deformations by the vias 208, a second layer 232 being a course screen for structural integrity and minimizing deformation of a porous belt 236, a third layer 234 being a fine mesh screen for supporting and reinforcing the porous belt 236 and a fourth layer being a porous belt 236 for allowing liquid to flow upwardly there through and to retain the liquid for a period. The porous belt 236 also provides a barrier for minimizing liquid from going down, due to gravity once pressed after a press cycle.

In a preferred embodiment, the top porous belt 236 in FIG. 4, is shown being movable or revolvable, around the frame 202, to minimize wear and provide simplified cleaning in conjunction with cleaning station 274, as shown as water jets in the figure. As an example, after a certain number of press cycles, such as five, the top porous belt 236 revolves a certain desired distance, and the jet sprayers are cycled on to clean and remove undesirable materials lodged or caught in the belt 236.

The porous belts 224 and 236 used in this application can include a Technoflex SI209240. The first stage queuing station 226 is attached to the frame 202 through a quick release connector, for simplified connection and release for cleaning and replacement.

In a preferred embodiment, a second frame 240 is provided, which is configured generally as a mirror image of the top frame 202. The second frame 240 can include: walls 242 and a first floor 244 and a basement floor 246, the first floor having a plurality of vias 248, the walls 242 and basement floor 246 defining a tray 250 adapted to hold a liquid; the basement floor 246 having an drain opening 252; and a porous buffer structure 254 located above a top 256 of the first floor 244. The second frame 240 is generally rectangular and has similar dimensions as the top frame 202, for a maximum press area.

The basement floor 246 has a drainage opening 252 configured to allow the liquid to flow there through due to gravity.

As detailed above, the porous buffer structure 254 is configured as a queuing station adapted to absorb liquid during a press cycle. The lower or second frame 240 comprises a plurality of porous layers 260. The porous layers 260 can include a first layer 262 being a fine mesh screen, a second layer 264 being a course screen for structural integrity and minimizing deformation of the porous buffer structure 260, and a third layer 266 being a fine mesh screen.

In one arrangement, a porous lower conveyor belt 224 is positioned above the porous buffer structure 254 for transporting material to be dewatered. Advantageously, the first attachment or frame 202 and the second attachment or frame 240 can be configured to press material to be dewatered to their respective porous buffer structures 220 and 254, for dewatering upwardly and downwardly, providing two escape routes for dewatering. This feature provides a high volume assembly line batch process for efficient and robust operations.

In a preferred embodiment, the press attachment 200 can include: a top frame 202 and a bottom frame 240, for improved dewatering, as the liquid in the material to be dewatered in an upper portion on the conveyor belt 224 will freely drain upwardly and the liquid in the material to be dewatered in an lower portion on the conveyor belt 224 will freely drain downwardly, during a press cycle.

As should be understood, the porous conveyor belt 224 is positioned above the porous buffer structure 254 of the lower frame 240 for transporting material to be dewatered, and the top frame 202 and the lower frame 240 are configured to press and transport liquid to their respective porous buffer structures 202 and 254 for dewatering, in am upwardly and downwardly direction.

In a preferred arrangement, the top frame 202 and lower frame 240 are configured with staging compartments or queuing stations 226 including a first stage 226 or compartment to convey water away from the material to be dewatered, a path to direct water from the first state to a second upper and lower stage 268 and 270 or compartment, through vias 208 in the floor 206 of the top frame 202 and vias 248 in the first floor 244 of the lower frame 240. The second stages 268 and 270 provide a temporary holding reservoir, for eventual drainage through drain opening 218 and 252, during a press cycle or after, when the floor 206 of the top frame 202 and the first floor 244 of the lower frame 240 are being pressed toward each other, reducing the available volume of the material to be dewatered, forcing the water to be expelled to the first stages 226 and 258, respectively.

In one embodiment, a vacuum 274 can be utilized to help pull the liquid from the first stage 226 to the second stage 268, through a hose 276. One or more spray jet cleaning stations 274 can be utilized to clean the conveyor 224 and 236, for improve efficiency in operation.

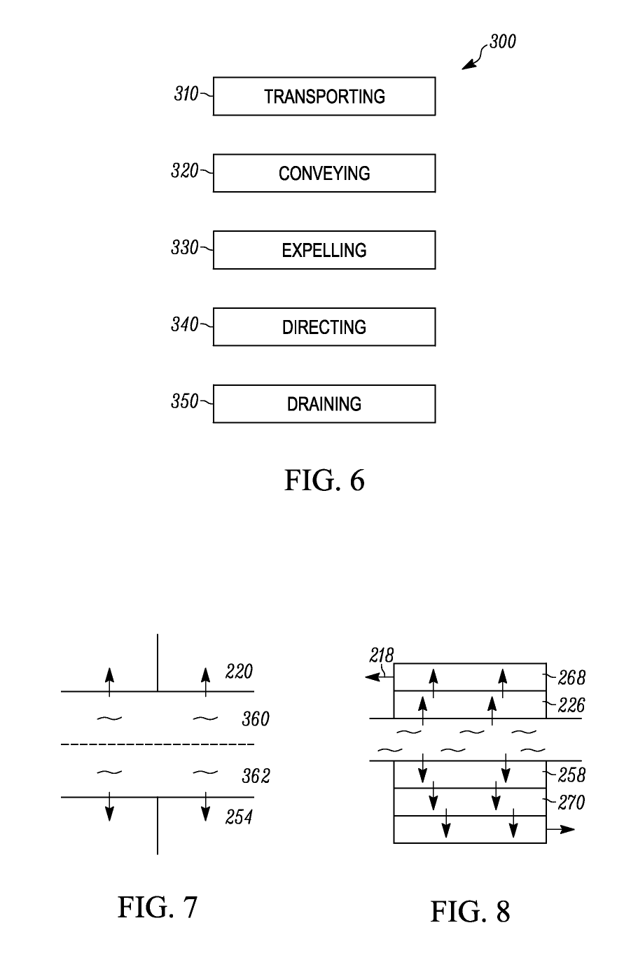

Referring to FIG. 6, a system 300 for removing water from material, is shown. It can include: transporting 310 a material to be dewatered on a porous conveyor belt; conveying 320 the material to be dewatered between a top press attachment and bottom press attachment to release moisture;

expelling 330 moisture to a porous buffer structure above the material in the top press attachment and below the material in the bottom press attachment;
directing 340 the expelled moisture to a top and bottom tray of the top and the bottom press attachments; and draining 350 the top and bottom trays. Advantageously, the system 300 provides two major escape routes for dewatering and provides a reliable, high volume assembly line batch process for efficient and robust operations.

The system 300 can be used to water a vast array of materials. For example, the material to be dewatered can include at least one of peat, human waste, animal waste, aluminium, ferrics, pharmaceutical products, chemical products, semiconductor products, drugs, foods, sewage sludge, oil sludge, water purification sludge, animal slurry sludge, fruit waste sludge, fresh peat sludge, milled peat sludge, paper sludge, de-inking sludge, paper fibers sludge and recycled diaper waste sludge.

In one arrangement, the expelling step 330 can include simultaneously expelling moisture to the porous buffer structure 220 above the material to be dewatered in the top press attachment or frame 202 and below the material to be dewatered in the lower press attachment or frame 240.

In more detail and as shown in FIG. 7, the expelling step 330 can include expelling moisture of an upper portion 360 of the material to be dewatered to the porous buffer structure 220 above the material to be dewatered in the upper frame 202 and expelling moisture of a lower portion 362 of the material to be dewatered below the material to be dewatered to the lower porous buffer structure 254 in the lower frame 240. Advantageously, this provides two major escape paths for the moisture to be expelled, upon initial compression and thereafter during a press cycle.

In one embodiment, the system 300 is configured with at least one porous buffer structure 220 and/or 254, to receive a surge of water during the expelling step 330 and in a press cycle operation.

In a preferred arrangement, the transporting step 310 can include transporting the expelled moisture to a top tray 210 through vias 208 and a plurality of pipes 214 having a certain height 216 in the upper frame 202 or top press attachment. Also, a drain 218 can be provided and located at least partially below the certain height 216 of the plurality of pipes 214, for passive draining.

In a preferred embodiment, as shown in FIGS. 4 and 8, the top frame 202 and/or lower frame 240 are configured with multiple staging compartments in an effort to expedite and simplify dewatering. For example, the staging compartments can include a first stage 226 compartment for conveying water away from the material to be dewatered, a path to direct water from the first stage 226 to a second stage 268 through vias 248 in the floor 244 of the lower frame 240 and through the vias 208 and pipes 214 in the upper frame 202, and a path to direct water from the first stage 226 to a second stage 268 to provide a temporary holding reservoir, for eventual drainage through opening 218. Likewise, for the upper frame 240, the water travels up to the first 226 and then the second stage 268, through the vias 208 and pipes 214. In operation, during a pressing cycle, the available volume, defining an enclosure, squeezes the material to be dewatered, forcing the water to be expelled to the first and then the second stage, and then to a drain. This is an efficient dewatering operation.

In one embodiment, a vacuum 272 can be utilized to “actively” pull water through the first and second stages 226 and 268, vias 208 and pipes 214, as shown in FIG. 4.

The transporting step 310 can include transporting the expelled moisture to a bottom through vias on a first floor 244 of the lower frame.

In one arrangement, the porous layers can be detached, with a release connector 238, as shown in FIG. 4.

In one arrangement, reinforcement structure is provided for the upper and lower frames. This is preferred because the frames 202 and 240 are under several thousand pounds of pressure, during a press cycle, and need structural integrity.

In one embodiment, the frames are provided with inclined floors for improved drainage.

In one embodiment, a dewatering agent can be mixed with the material to be dewatered, for improved results. Some dewatering agents can comprise at least one of peat, previously dried peat, milled rice husks, milled nut shells, milled corn cob, milled palm frans, milled bamboo, milled strand board, milled wood, and milled polyethylene powder.

In one arrangement, the expelling step 330 includes reducing the available volume of the material to be dewatered, during a pressing cycle, and thereby providing a progressive reduction in an enclosure, defined by the upper and lower frames 202 and 240, to product separation of the material and water.

In a preferred embodiment, the upper and lower frames are configured with staging compartments including a first stage compartment to convey water away from the material to be dewatered and a second stage compartment to provide a temporary holding reservoir, for eventual drainage.

### Example One

The following table shows the weight reduction produced in a small bench scale experiment for a number of different mixtures. A chamber which was twelve inches deep and had a six inch diameter was filled with 4, 6 and 8 inches of sludge and the indicated mixture. The chamber had a series of holes on the floor spaced about one centimeter apart in a series of decreasing circular arrangements. The about 40 holes had about a five millimeter diameter. A filter was placed adjacent to the floor and comprised a conventional porous belt. A like sized circular piston with a substantially flat and circular end was used to apply a downward pressure toward the floor of the chamber for about 30 to 60 seconds. The initial pressure was about 200 psi and final pressure was about 1000 psi. It was observed that most of the water escaped through the holes upon the initial downward pressure, and thereafter additional water exited the chamber. In more detail, a large amount of wastewater was expelled from the mixture at lower pressures, but if compression is maintained, additional wastewater is expelled as well from the mixture.

TABLE 1

| | | Total | Total | |
|---|---|---|---|---|
| Mixture | Weights | Before | After | Reduction |
| Wood Shavings | 50 g | 550 g | 190 g | 360 g |
| Biosolids (13% Dry Solids) | 500 g | | | |
| Milled Peat | 200 g | 700 g | 325 g | 375 g |
| Biosolids (13% Dry Solids) | 500 g | | | |
| Shredded Newsprint | 20 g | 200 g | 80 g | 120 g |
| Biosolids (11% Dry Solids) | 180 g | | | |

g equals grams

### Example Two

In a preferred embodiment, good results were achieved in the following manner.

A sewage sludge sample of undigested sludge cake with a moisture level of 87% was mixed at a rate of 18% with a dry MDF wood dust. The mix was placed in the dewatering device at a depth of 5 inches (125 mm). The following results were obtained from three batches of the above mix.

Batch 1 was compressed at a pressure of 250 pounds per square inch (psi). The additive was separated from the compressed sludgecake afterwards. The moisture content of the compressed sludgecake was 44.6% moisture. This was a decrease of about 42.4 points of moisture.

Batch 2 was compressed at a pressure of 500 psi. The additive was separated from the compressed sludgecake afterwards. The moisture content of the compressed sludgecake was 36.03% moisture. This was a decrease of about 50.97 points of moisture.

Batch 3 was compressed at a pressure of 1000 psi. The additive was separated from the compressed sludgecake afterwards. The moisture content of the compressed sludgecake was 31.09% moisture. This was a decrease of about 55.91 points of moisture.

TABLE 2

| | | | | Reduction |
|---|---|---|---|---|
| Mixture | Weights | Solids | Moisture | Improvement |
| Original Sludge | 100 lbs | 13% | 87% | |
| Batch 1 | 23.46 lbs | 55.4% | 44.6% | 42.4% pts |
| Batch 2 | 20.32 lbs | 63.97% | 36.03% | 50.97% pts |
| Batch 3 | 18.86 lbs | 68.91% | 31.09% | 55.91% pts |
| Solids (13 lbs in Orig | | | | |
| and Batches 1-3) | | | | |

Advantageously, Batches 1-3 provide a dewatered sludgecake which is greatly reduced in weight and odor, and further, is adapted for further processing or disposal, as previously detailed.

In more detail, the result is a greatly dewatered sludgecake with reduced weight and odor. Use of this process, can result in a reduced moisture-level end product, with more manageable properties and can have a dry solids content approaching upwards of 50-70%. The process provides a substantial improvement in dewatering sludgecake and reducing weight, as opposed to known conventional moisture extraction techniques. This can help in providing more effective and efficient transport of the dewatered sludgecake and blending material.

### Example 3

In experiments relating to dewatering peat, it was found that by mixing the wet peat at varying moisture contents ie. 40-95% with another material and then subjecting this material to pressure in an apparatus with a filter cloth or medium and porous plate to pressures ranging from 50 psi to 4000 psi, then the vast majority of the water can be expelled mechanically from the peat.

By taking previously dried peat and/or dried and milled peat and mixing it with the wet peat at a ratio of between 2% and 75% by weight and depending on the moisture content of the wet peat that this dewatering is possible.

### Example A

100 kilograms wet peat at 75% moisture and 15 kilograms dried peat at 20% moisture, were mixed totaling 115 kilograms of mixed peat at 68% moisture. After pressing the 115 kg, the weight was reduced to 57.8 kg or 36% moisture.

### Example B

100 kg wet peat at 82% moisture and 23 kg dried milled peat at 17% moisture, were mixed totaling 123 kg mixed peat at 70% moisture. After pressing the 123 kg the weight was reduced to 63.9 kg or 42% moisture.

### Example C

100 kg wet peat at 91% moisture and 30 kg dried milled peat at 18% moisture were mixed totaling 130 kg mixed peat at 75% moisture. After pressing the 130 kg, the weight was reduced to 55 kg or 39% moisture.

### Example D

100 kg wet peat at 78% moisture and 20 kg dry exploded wood fiber at 11% moisture were mixed totaling 120 kg mixed material at 60% moisture. After pressing the 120 kg, the weight was reduced to 63 kg or 37% moisture.

As should be understood by those skilled in the art, the invention is not limited to the embodiments described herein, and may be modified or varied without departing from the scope of the invention.

1. A press attachment including:
a frame including walls and a floor having a plurality of vias, the walls and floor defining a tray adapted to hold a liquid;
pipes extending upwardly from the plurality of vias a predetermined height above the floor;
the walls having an drain opening; and
a porous buffer structure located below a bottom of the floor and connected to the frame.

2. The press attachment of claim 1, wherein the frame is generally rectangular.

3. The press attachment of claim 1, wherein the drain opening is substantially positioned at least partially below the predetermined height of the pipes.

4. The press attachment of claim 1, wherein the drain opening is substantially positioned at least partially below the predetermined height of the pipes to allow the liquid to flow through the drain opening due to gravity.

5. The press attachment of claim 1, wherein a top of the floor is inclined to provide a path to the drain opening.

6. The press attachment of claim 1, wherein the plurality of vias have the same or different diameters.

7. The press attachment of claim 1, wherein the pipes have the same or different diameters.

8. The press attachment of claim 1, wherein the porous buffer structure is configured as a queuing station adapted to absorb liquid for a certain period of time.

9. The press attachment of claim 1, wherein the porous buffer structure is configured as a queuing station adapted to absorb liquid and comprises a plurality of porous layers.

10. The press attachment of claim 1, wherein the porous buffer structure is configured as a queuing station adapted to absorb liquid and comprises a plurality of porous layers, the porous layers including a first layer being a fine mesh screen to minimize pot mark like deformations by the vias, a second layer being a course screen for structural integrity and minimizing deformation of a belt, a third layer being a fine mesh screen for supporting and reinforcing the belt and a fourth layer being a porous belt for allowing liquid to flow upwardly through and to retain the liquid for a period.

11. The press attachment of claim 1, further comprising a second frame configured generally as a mirror image of the frame.

12. The press attachment of claim 1, further comprising a second frame including:
walls and a first floor an a basement floor, the first floor having a plurality of vias, the walls and basement floor defining a tray adapted to hold a liquid;
the basement floor having an drain opening; and
a porous buffer structure located above a top of the first floor.

13. The press attachment of claim 12, wherein the second frame is generally rectangular.

14. The press attachment of claim 11, wherein the basement floor has a drainage opening configured to allow the liquid to flow there through due to gravity.

15. The press attachment of claim 11, wherein the porous buffer structure is configured as a queuing station adapted to absorb liquid.

16. The press attachment of claim 11, wherein the porous buffer structure is configured as a queuing station adapted to absorb liquid and comprises a plurality of porous layers, the porous layers including a first layer being a fine mesh screen, a second layer being a course screen for structural integrity and minimizing deformation of the porous buffer structure, and a third layer being a fine mesh screen.

17. The press attachment of claim 11, further comprising a porous conveyor belt positioned above the porous buffer structure for transporting material to be dewatered, the first attachment and the second attachment configured to press material on the porous buffer structure for dewatering.

18. A press attachment including:
a top frame including walls and a floor having a plurality of vias, the walls and floor defining a tray adapted to hold a liquid;
pipes extending upwardly from the plurality of vias a predetermined height above the floor;
the walls having an drain opening; and
a porous buffer structure located below a bottom of the floor and connected to the frame; and
a bottom frame including:
walls and a first floor and a basement floor, the first floor having a plurality of vias, the walls and basement floor defining a tray adapted to hold a liquid;
the basement floor having an drain opening; and
a porous buffer structure located above a top of the first floor.

19. The press attachment of claim 18, further comprising a porous conveyor belt positioned above the porous buffer structure of the bottom frame for transporting material to be dewatered, the top frame and the bottom frame configured to press material on the porous buffer structure for dewatering.

20. The press attachment of claim 18, wherein the top frame and bottom frame are configured with staging compartments including a first stage compartment to convey water away from the material to be dewatered, a path to direct water from the first station to a second stage compartment through vias in the floor of the top frame and the first floor of the bottom frame, and the second stage compartment to provide a temporary holding reservoir, for eventual drainage, when the floor of the top frame and the first floor of the bottom frame are being pressed toward each other reducing the available volume of the material to be dewatered, forcing the water to be expelled therebetween.

21. A system for removing water from material, comprising:
transporting a material to be dewatered on a porous conveyor belt; conveying the material to be dewatered between an upper frame and a lower frame to release moisture;
expelling moisture to a porous buffer structure above the material in the upper frame and below the material in the lower frame;
directing the expelled moisture to a top and bottom tray of the upper and lower frames; and
draining the top and bottom trays.

22. The system of claim 21, wherein the material to be dewatered includes at least one of peat, human waste, animal waste, aluminium, ferries, pharmaceutical products, chemical products, semiconductor products, drugs, foods, sewage sludge, oil sludge, water purification sludge, animal slurry sludge, fruit waste sludge, fresh peat sludge, milled peat sludge, paper sludge, de-inking sludge, paper fibers sludge and recycled diaper waste sludge.

23. The system of claim 21, wherein the expelling step includes simultaneously expelling moisture to the porous buffer structure above the material to be dewatered in the upper frame and below the material to be dewatered in the lower frame.

24. The system of claim 21, wherein the expelling step includes expelling moisture of an upper portion of the material to be dewatered to the porous buffer structure above the material to be dewatered in the upper frame and expelling moisture of a lower portion of the material to be dewatered below in the lower frame.

25. The system of claim 21, wherein the expelling step includes initially expelling moisture of an upper portion of the material to be dewatered to the porous buffer structure in the upper frame and initially expelling moisture of a lower portion of the material to be dewatered below in the lower frame, upon initial compression and thereafter.

26. The system of claim 21, further comprising configuring the porous buffer structures to receive a surge of water during the expelling step.

27. The system of claim 21, wherein the transporting step includes transporting the expelled moisture to an upper tray via a plurality of pipes having a certain height attached to a floor of the upper frame.

28. The system of claim 21, wherein the transporting step includes transporting the expelled moisture to a top tray via a plurality of pipes having a certain height attached to a top portion of a floor of the upper frame and providing a drain located at least partially below the certain height of the plurality of pipes.

29. The system of claim 21, further comprising providing a top frame and bottom frame configured with staging compartments including a first stage compartment to convey water away from the material to be dewatered and the second stage compartment to provide a temporary holding reservoir.

30. The system of claim 21, further comprising providing a vacuum system configured to enhance dewatering.

31. The system of claim 21, wherein the transporting step includes transporting the expelled moisture to a bottom through vias on a first floor of the bottom press attachment.

32. The system of claim 21, wherein providing the porous buffer structures with a detachable connector.

33. The system of claim 21, further comprising providing reinforcement structure for the upper and the lower frames.

34. The system of claim 21, further comprising providing inclined surfaces configured to direct water to a drain.

35. The system of claim 21, further comprising mixing a dewatering agent with the material to be dewatered.

36. The system of claim 21, wherein the dewatering agent comprises at least one of peat, processed peat, milled rice husks, milled nut shells, milled corn cob, milled palm franc, milled bamboo, milled strand board, milled wood, and milled polyethylene powder.

37. A system for removing water from material, comprising:
conveying a material to be dewatered on a porous conveyor belt; compressing the material to be dewatered between an upper frame and a lower frame to release moisture;
expelling moisture to a porous buffer structure above the material in the upper frame and below the material below in the lower frame; and
directing the expelled moisture to a top and bottom tray of the upper and the lower frames; and
draining the top and bottom trays, wherein the expelling step includes expelling moisture of an upper portion of the material to be dewatered to the porous buffer structure above the material to be dewatered in the upper frame and expelling moisture of a lower portion of the material to be dewatered below in the lower frame.

38. The system of claim 37, wherein the expelling step includes reducing the available volume of the area surrounding the material to be dewatered.

39. The system of claim 37, further comprising configuring the top press attachment and the bottom press attachment with staging compartments including a first stage compartment to convey water away from the material to be dewatered and a second stage compartment to provide a temporary holding reservoir, for eventual drainage.
